(19) United States
(12) Patent Application Publication
(10) Pub. No.: US 2021/0131320 A1
(43) Pub. Date: May 6, 2021

(54) DRAIN VALVE OF OIL CUP OF OIL FILTER

(71) Applicant: I-Sin Peng, Taichung City (TW)

(72) Inventor: I-Sin Peng, Taichung City (TW)

(21) Appl. No.: 16/668,056

(22) Filed: Oct. 30, 2019

(51) Int. Cl. F01M 11/04; F16K 5/06

(52) U.S. Cl. CPC F01M 11/0408; F01P 11/0276; F16K 5/0647

(57) ABSTRACT

A drain valve of an oil cup of an oil filter contains: a body and a fitting sleeve. The body includes a head portion, a post, a connection portion, an upper threaded portion, a lower threaded portion, and a foot portion. An air channel and a fluid channel are defined between the head portion and the connection portion, and the connection portion has multiple cutouts and a guide opening. The foot portion has a through orifice communicating with the guide opening. The fitting sleeve includes a peripheral fence, an internal screwing portion, and multiple positioning portions. A distance is defined between the connection portion and the fitting sleeve by ways of the positioning portion so that air and stems discharge out of the foot portion from the oil filter along the guide opening.

### FIELD OF THE INVENTION

The present invention relates to an oil filter, and more particularly to a drain valve of an oil cup of the oil filter.

### BACKGROUND OF THE INVENTION

A conventional drain valve structure of an oil filter is disclosed in U.S. Pat. No. 9,631,760 and contains a body and a fitting sleeve.

The body includes a head portion, a post, a connection portion, an external threaded portion, and a foot portion. The post is configured to connect the head portion with the foot portion, the external threaded portion includes an upper segment and a lower segment which are separated by the connection portion, and the connection portion abuts against a bottom of the fitting sleeve, inner threads of the fitting sleeve is screwed with the external threaded portion.

The post is hollow, the head portion includes an air inlet and a fluid inlet which are defined adjacent to an end of the head portion, the foot portion includes an air outlet and a fluid outlet, and the body includes a partition configured to separate the air inlet, the air outlet, the fluid inlet, and the fluid outlet.

The fitting sleeve is arranged below the body and includes a screwing portion for controlling the body to locate at a closing position or an opening position so as to discharge the water.

The conventional drain valve structure of the present invention has defects as follows:

1. The oil filter is configured to separate the water and dirty substances in oil. When the water and oily gas exist in the oil filter, the drain valve discharges the water, but the water mixes with a part of the oily gas or a pressure difference produces in the oil filter, the water cannot be discharged out of the air inlet and the fluid inlet. Thus, the gas inlet and the fluid inlet are rotated to contact with the oil filter so as to discharge the water. When the water is discharged poorly, the oil filter has to be removed manually so as to discharge the water.

2. Since the partition is fixed on a center of the body, the air inlet and the fluid inlet are perpendicular to the partition, so the drain valve is complicated. In addition, it is necessary to provide a mold to produce the body, thus decreasing manufacture yield and increasing fabrication cost. The partition is too thin to remove from the fixing bolt when detaching the partition from the mold.

The present invention has arisen to mitigate and/or obviate the afore-described disadvantages.

### SUMMARY OF THE INVENTION

The primary aspect of the present invention is to provide a drain valve of an oil cup of an oil filter in which a distance is defined between the connection portion and the bottom of the fitting sleeve so that the water is discharged out of the guide opening smoothly, and the pressure of the oil filter is adjustable to discharge the water easily.

Further aspect of the present invention is to provide a drain valve of an oil cup of an oil filter by which when the head portion is inserted into the oil filter, the air flows into the guide opening via the air channel, and the water flows into the guide opening via the fluid channel, thus discharging the water; and the external air is guided to flow into the oil filter from the guide opening so as to release the pressure out of the oil filter, thus discharging the water quickly.

Another aspect of the present invention is to provide a drain valve of an oil cup of an oil filter in which the body is simplified to enhance manufacture yield and to reduce fabrication cost.

To obtain above-mentioned aspects, a drain valve of an oil cup of an oil filter provided by the present invention contains: a body (1) and a fitting sleeve (2).

The body (1) includes a head portion (11), a post (12), a connection portion (13), an upper threaded portion (14), a lower threaded portion (15), and a foot portion (16).

The head portion (11) is formed on a top of the post (12), an air channel (111) and a fluid channel (112) are defined between the head portion (11) and the connection portion (13), wherein the connection portion (13) is formed on an intermediate section of the post (12) in a disk shape, and the connection portion (13) has multiple cutouts (131) arranged around a peripheral side thereof and has a guide opening (132) formed on a bottom of the connection portion (13); the lower threaded portion (14) is separated from the lower threaded portion (15) by the connection portion (13), wherein the upper threaded portion (15) is in connection with an outlet (101) of the oil filter (100), and the lower threaded portion (15) is coupled with the fitting sleeve (2); the foot portion (16) is formed on a bottom of the post (12) and has a through orifice (161) communicating with the guide opening (132).

The fitting sleeve (2) includes a peripheral fence (21), an internal screwing portion (22), and multiple positioning portions (23); the internal screwing portion (22) is screwed with the lower threaded portion (15) of the body (1), and the peripheral fence (21) extends to the head portion (11) of the body (1) from the internal threaded portion (22); the fitting sleeve (2) is fixed with the body (1) by using a fixing loop (24), the multiple positioning portions (23) correspond to the multiple cutouts (131) of the connection portion (13) so that the body (1) is actuated by the fitting sleeve (2) to rotate; a distance (D) is defined between the connection portion (13) and the fitting sleeve (2) by ways of the positioning portion (23) so that water is discharged out of the foot portion (16) from the oil filter (100) along the guide opening (132).

Preferably, the head portion (11) is connected with a fixer (17) hooked with the oil filter (100).

Preferably, a seal ring (3) is defined between the connection portion (13) and the outlet (101) of the oil filter (100).

Preferably, the fitting sleeve (2) includes multiple non-skid ribs (25) formed around the peripheral fence (21).

### BRIEF DESCRIPTION OF THE DRAWINGS

FIG. 1 is a perspective view showing the assembly of a drain valve of an oil cup of an oil filter according to a preferred embodiment of the present invention.

FIG. 2 is a bottom plan view showing the assembly of the drain valve of the oil cup of the oil filter according to the preferred embodiment of the present invention.

FIG. 3 is a cross sectional view taken along the line A-A of FIG. 2.

FIG. 4 is a perspective view showing the assembly of a part of the drain valve of the oil cup of the oil filter according to the preferred embodiment of the present invention.

FIG. 5 is a cross-sectional perspective view taken along the line B-B of FIG. 4.

FIG. 6 is a perspective view showing the assembly of a part of the drain valve of the oil cup of the oil filter according to the preferred embodiment of the present invention.

FIG. 7 is a perspective view showing the exploded components of the drain valve of the oil cup of the oil filter according to the preferred embodiment of the present invention.

FIG. 8 is a cross sectional view showing the operation of the drain valve of the oil cup of the oil filter according to the preferred embodiment of the present invention.

### DETAILED DESCRIPTION OF THE PREFERRED EMBODIMENTS

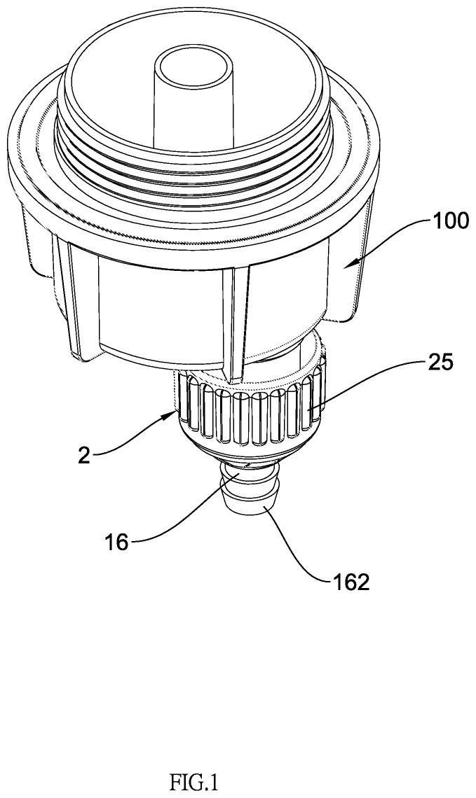

With reference to FIGS. 1, 3, 7, a drain valve of an oil cup of an oil filter according to a preferred embodiment of the present invention comprises: a body (1) and a fitting sleeve (2). The drain valve is mounted on a bottom of the oil filter (100) so as to discharge water, to guide external air to flow into the oil filter 100, and to release a pressure out of the oil filter 100, thus discharging the water quickly. Preferably, the drain valve is applicable for water filter or an oil-water filter.

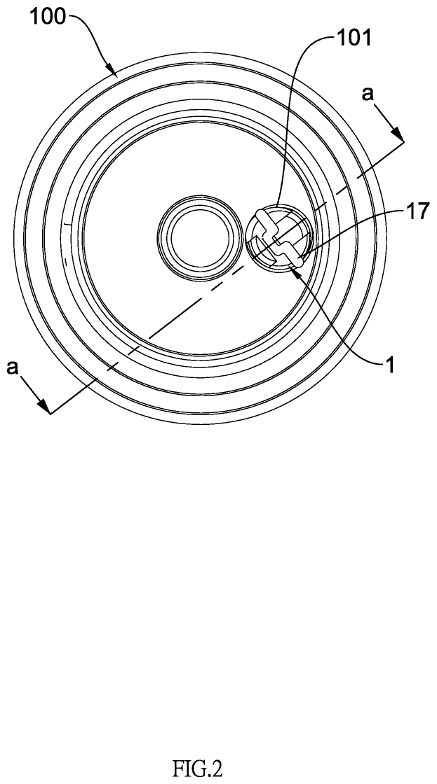

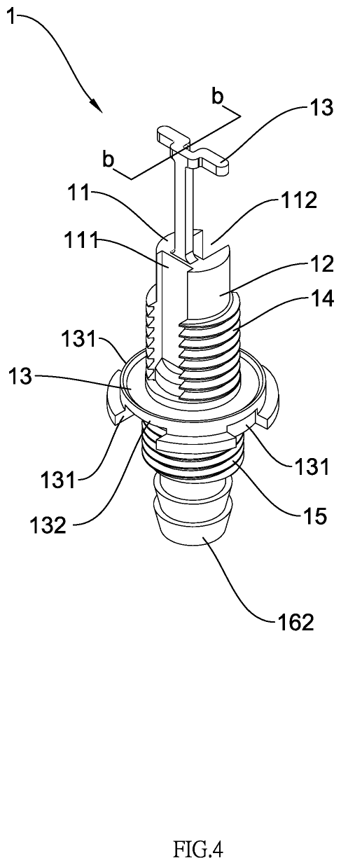

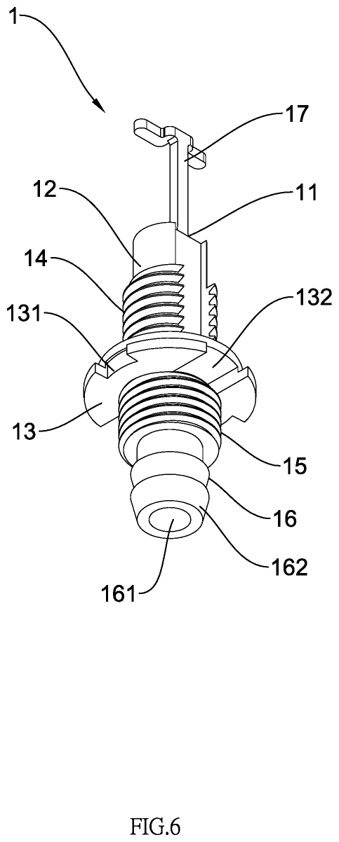

Referring to FIGS. 1-7, the body (1) includes a head portion (11), a post (12), a connection portion (13), an upper threaded portion (14), a lower threaded portion (15), and a foot portion (16).

The head portion (11) is formed on a top of the post (12), an air channel (111) and a fluid channel (112) are defined between the head portion (11) and the connection portion (13), wherein the connection portion (13) is formed on an intermediate section of the post (12) in a disk shape, and the connection portion (13) has multiple cutouts (131) arranged around a peripheral side thereof and has a guide opening (132) formed on a bottom of the connection portion (13). The lower threaded portion (14) is separated from the lower threaded portion (15) by the connection portion (13), wherein the upper threaded portion (15) is in connection with an outlet (101) of the oil filter (100), and the lower threaded portion (15) is coupled with the fitting sleeve (2). The foot portion (16) is formed on a bottom of the post (12) and has a through orifice (161) communicating with the guide opening (132).

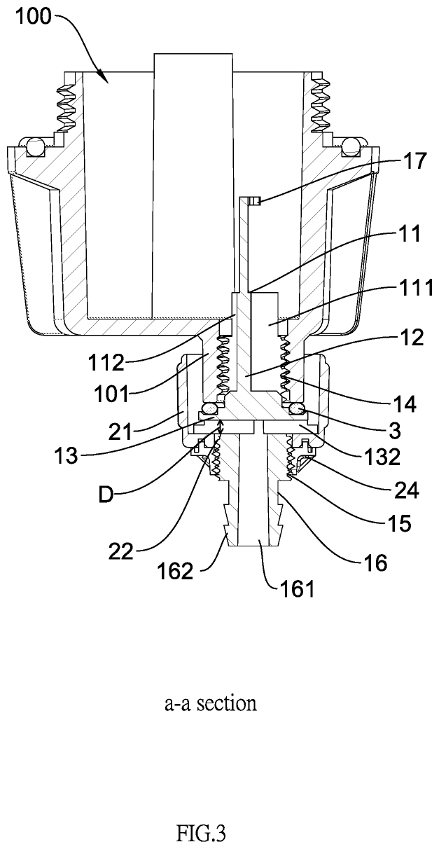

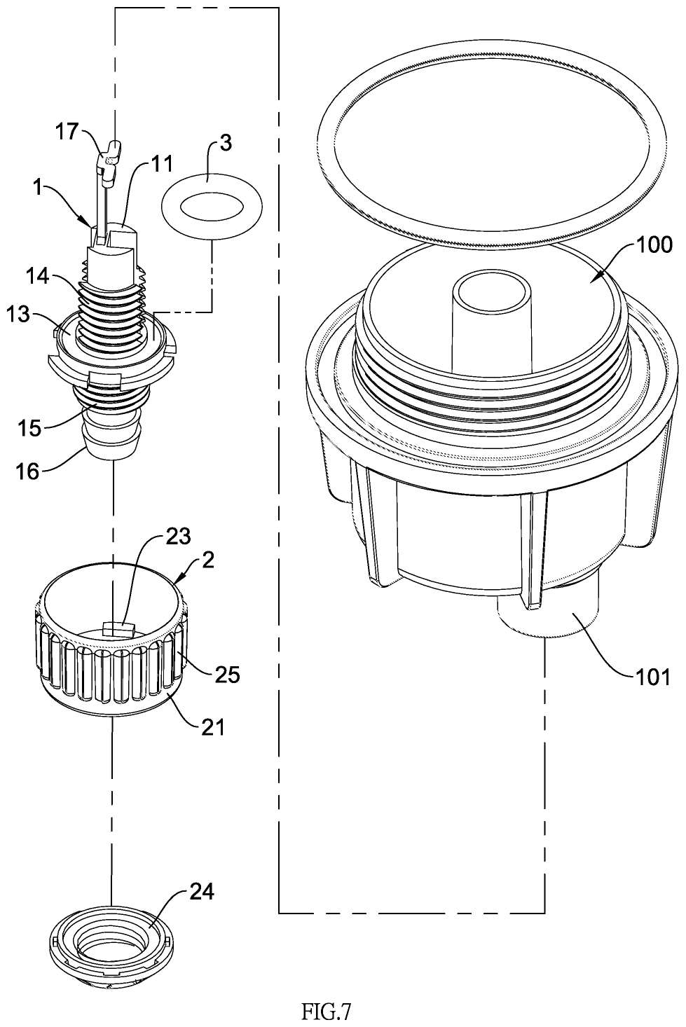

As shown in FIGS. 1-6, the head portion (11) is connected with a fixer (17) hooked with the oil filter (100) so as to avoid a removal of the oil filter (100). As illustrated in FIGS. 3 and 7, a seal ring (3) is defined between the connection portion (13) and the outlet (101) so as to avoid the water flowing into the oil filter (100).

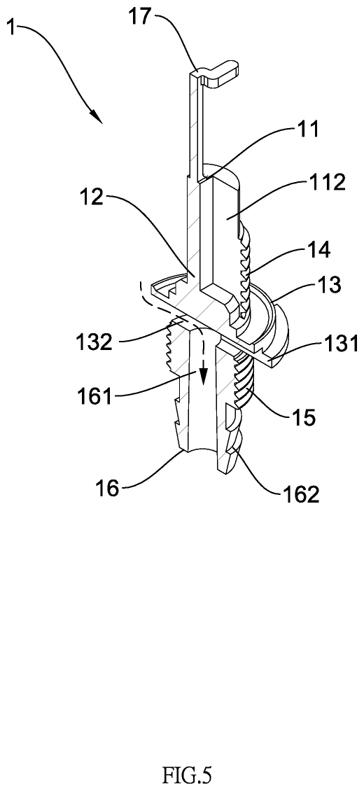

Referring to FIGS. 1, 3, and 7, the fitting sleeve (2) includes a peripheral fence (21), an internal screwing portion (22), and multiple positioning portions (23). The internal screwing portion (22) is screwed with the lower threaded portion (15) of the body (1), and the peripheral fence (21) extends to the head portion (11) of the body (1) from the internal threaded portion (22). The fitting sleeve (2) is fixed with the body (1) by using a fixing loop (24), as shown in FIG. 7, the multiple positioning portions (23) correspond to the multiple cutouts (131) of the connection portion (13) so that the body (1) is actuated by the fitting sleeve (2) to rotate. Referring further to FIGS. 3 and 5, a distance (D) is defined between the connection portion (13) and the fitting sleeve (2) by ways of the positioning portion (23) so that the air and the stems discharge out of the foot portion (16) from the oil filter (100) along the guide opening (132).

With reference to FIGS. 1, 3, and 7, the fitting sleeve (2) includes multiple non-skid ribs (25) formed around the peripheral fence (21) so as to avoid sliding when rotating the fitting sleeve (2). As shown in FIGS. 1 and 3, the foot portion (16) has a stepped orifice (162) defined thereon and connects with a drain pipe (not shown) so as to discharge the water out of the oil filter (100) easily.

Thereby, the drain valve of the present invention has advantages as follows:

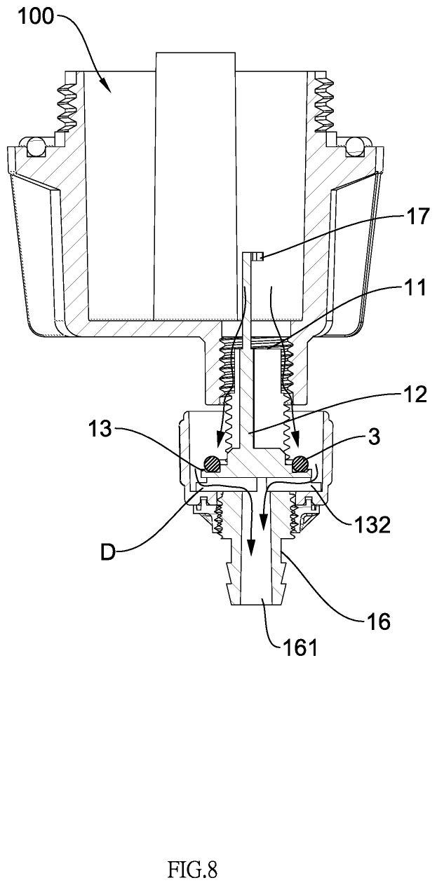

1. Referring to FIG. 8, when the water accumulates in the oil filter (100) overly, the fitting sleeve (2) is rotated so that the upper threaded portion (15) move away from the outlet (101), and the distance (D) between the fitting sleeve (2) and the connection portion (13) is increased so that the water is discharged out of the through orifice (161) of the foot portion (16) via the guide opening (132).

2. As shown in FIG. 8, a cross-sectional area of the air channel (111) is different from that of the fluid channel. When the head portion (11) is inserted into the oil filter (100), the air flows into the guide opening (132) via the air channel (111), and the water flows into the guide opening (132) via the fluid channel (112), thus discharging the water. Preferably, the external air is guided to flow into the oil filter (100) from the guide opening (132) so as to release the pressure out of the oil filter (100), thus discharging the water quickly.

3. As illustrated in FIG. 8, the distance (D) is defined between the connection portion (13) and the bottom of the fitting sleeve (2) so that the water is discharged out of the guide opening (132) smoothly, and the pressure of the oil filter (100) is adjustable to discharge the water easily.

4. The body (1) is simplified to enhance manufacture yield and to reduce fabrication cost.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention

What is claimed is:

1. A drain valve of an oil cup of an oil filter comprising: a body (1) and a fitting sleeve (2);
the body (1) including a head portion (11), a post (12), a connection portion (13), an upper threaded portion (14), a lower threaded portion (15), and a foot portion (16);
wherein the head portion (11) is formed on a top of the post (12), an air channel (111) and a fluid channel (112) are defined between the head portion (11) and the connection portion (13), wherein the connection portion (13) is formed on an intermediate section of the post (12) in a disk shape, and the connection portion (13) has multiple cutouts (131) arranged around a peripheral side thereof and has a guide opening (132) formed on a bottom of the connection portion (13); the lower threaded portion (14) is separated from the lower threaded portion (15) by the connection portion (13), wherein the upper threaded portion (15) is in connection with an outlet (101) of the oil filter (100), and the lower threaded portion (15) is coupled with the fitting sleeve (2); the foot portion (16) is formed on a bottom of the post (12) and has a through orifice (161) communicating with the guide opening (132);
wherein the fitting sleeve (2) includes a peripheral fence (21), an internal screwing portion (22), and multiple positioning portions (23); the internal screwing portion (22) is screwed with the lower threaded portion (15) of the body (1), and the peripheral fence (21) extends to the head portion (11) of the body (1) from the internal threaded portion (22); the fitting sleeve (2) is fixed with the body (1) by using a fixing loop (24), the multiple positioning portions (23) correspond to the multiple cutouts (131) of the connection portion (13) so that the body (1) is actuated by the fitting sleeve (2) to rotate; a distance (D) is defined between the connection portion (13) and the fitting sleeve (2) by ways of the positioning portion (23) so that air and stems discharge out of the foot portion (16) from the oil filter (100) along the guide opening (132).

2. The drain valve as claimed in claim 1, wherein the head portion (11) is connected with a fixer (17) hooked with the oil filter (100).

3. The drain valve as claimed in claim 1, wherein a seal ring (3) is defined between the connection portion (13) and the outlet (101) of the oil filter (100).

4. The drain valve as claimed in claim 1, wherein the fitting sleeve (2) includes multiple non-skid ribs (25) formed around the peripheral fence (21).
